(19) United States
(12) Patent Application Publication
(10) Pub. No.: US 2025/0086154 A1
(43) Pub. Date: Mar. 13, 2025

(54) SEMICONDUCTOR PRODUCT EVALUATION DATA MANAGEMENT SYSTEM, SEMICONDUCTOR PRODUCT EVALUATION DATA MANAGEMENT METHOD, AND NON-TRANSITORY COMPUTER-READABLE STORAGE MEDIUM STORING A SEMICONDUCTOR PRODUCT EVALUATION DATA MANAGEMENT PROGRAM

(71) Applicant: Kioxia Corporation, Tokyo (JP)

(72) Inventors: Mami KODAMA, Yokohama Kanagawa (JP); Taisuke ICHIKAWA, Yokohama Kanagawa (JP); Masaki YOSHIMURA, Arakawa Tokyo (JP); Nachi OGURO, Yokohama Kanagawa (JP); Yuki FURUKAWA, Fujisawa Kanagawa (JP)

(73) Assignee: Kioxia Corporation, Tokyo (JP)

(21) Appl. No.: 18/829,555

(22) Filed: Sep. 10, 2024

(30) Foreign Application Priority Data
Sep. 11, 2023 (JP) 2023-146781

(51) Int. Cl. G06F 16/22; G06F 16/11; G06F 16/23

(52) U.S. Cl. CPC G06F 16/2228; G06F 16/113; G06F 16/2358

(57) ABSTRACT

According to one embodiment, a semiconductor product evaluation data management system includes a computer server that manages evaluation data of a semiconductor product and a plurality of storage devices that store the evaluation data. The computer server includes a storage data index file configured to store an index attached to the evaluation data to be stored in the computer server and the plurality of storage devices; a storage data index updating unit configured to store and update manufacturing information of semiconductor product in the index; and a storing method updating unit configured to control movement of the evaluation data to a specific storage device among the plurality of storage devices in a unit of the manufacturing information of the semiconductor product in accordance with the index.

### CROSS REFERENCE TO RELATED APPLICATIONS

This application is based upon and claims the benefit of priority from prior Japanese Patent Application No. P2023-146781 filed on Sep. 11, 2023, the entire contents of which are incorporated herein by reference.

### FIELD

Embodiments described herein relate generally to a semiconductor product evaluation data management system, a semiconductor product evaluation data management method, and a non-transitory computer-readable storage medium storing a semiconductor product evaluation data management program.

### BACKGROUND

For semiconductor memories, for example, electrical evaluation in a unit of wafer is performed in a pre-process of fabrication, and electrical evaluation in a unit of chip is performed after dividing the wafer into a plurality of chips in a post-process. Even in such a product inspection ranging over a plurality of inspection processes, a mechanism has been proposed that enables comprehensive analysis ranging over the plurality of processes.

Moreover, even when various evaluation data of semiconductor products is stored in a storage (e.g., storage device) or the like, only some experienced experts can utilize the stored data. Therefore, a mechanism has been proposed that allows even non-experts to easily identify failure factors and the like.

### BRIEF DESCRIPTION OF THE DRAWINGS

FIG. 1 is an overall configuration diagram of a semiconductor product evaluation data management system according to an embodiment.

FIG. 2A is a schematic internal block configuration diagram of a computer server according to the embodiment.

FIG. 2B is a partial block configuration diagram (1 of 2) of the semiconductor product evaluation data management system according to the embodiment.

FIG. 2C is a partial block configuration diagram (2 of 2) of the semiconductor product evaluation data management system according to the embodiment.

FIG. 3 is an outline flowchart of processing executed by a data receiving and storing processing unit, in a semiconductor product evaluation data management method according to the embodiment.

FIG. 4 illustrates an example of a measured result file used by the computer server according to the embodiment.

FIG. 5 illustrates an example of a master file used by the computer server according to the embodiment.

FIG. 6A illustrates an example of a determination result of failure classification for each chip by the computer server according to the embodiment.

FIG. 6B illustrates an example of a wafer map representing a failure classification for each chip by the computer server according to the embodiment.

FIG. 7 illustrates an example of evaluation analysis information (in unit of chip) by the computer server according to the embodiment.

FIG. 8 illustrates an example of evaluation analysis information (in unit of lot) by the computer server according to the embodiment.

FIG. 9 illustrates an example of a data storing rule file used by the computer server according to the embodiment.

FIG. 10 illustrates an example of a storage data index used by the computer server according to the embodiment.

FIG. 11A is an outline flowchart (1 of 2) of processing executed by an automatic analysis and storing method changing unit, in the semiconductor product evaluation data management method according to the embodiment.

FIG. 11B is an outline flowchart (2 of 2) of the processing executed by an automatic analysis and storing method changing unit, in the semiconductor product evaluation data management method according to the embodiment.

FIG. 12 illustrates an example of correlation analysis information (in unit of chip) over a plurality of processes by the computer server according to the embodiment.

FIG. 13 is an outline flowchart of processing executed by an analytical procedure and teaching data creating unit, in the semiconductor product evaluation data management method according to the embodiment.

### DETAILED DESCRIPTION

Next, certain embodiments will now be explained with reference to drawings. In the description of the following specification or drawings to be explained, the identical or similar reference sign is attached to the identical or similar part. However, the drawings are merely schematic. Moreover, the embodiments described hereinafter merely exemplify a device and/or a method for materializing the technical idea. The embodiments may be changed without departing from the spirit or scope of claims.

Certain embodiments provide a semiconductor product evaluation data management system, a semiconductor product evaluation data management method and a non-transitory computer-readable storage medium storing a semiconductor product evaluation data management program, capable of improving efficiency of an evaluation analysis of a large amount of evaluation data in evaluation data management of semiconductor products.

In general, according to the embodiment, a semiconductor product evaluation data management system includes a computer server configured to manage evaluation data of a semiconductor product and a plurality of storage devices configured to store the evaluation data. The computer server includes: a storage data index file configured to store a storage data index attached to the evaluation data to be stored in the computer server and the plurality of storage devices; a storage data index updating unit configured to store and update the manufacturing information of the semiconductor product in the storage data index; and a storing method updating unit configured to control movement of the evaluation data to a specific storage device among the plurality of storage devices in a unit of the manufacturing information of the semiconductor product in accordance with the storage data index.

Hereinafter, a semiconductor product evaluation data management system of a semiconductor integrated circuit, a semiconductor product evaluation data management method, and a non-transitory computer-readable storage medium storing a semiconductor product evaluation data management program, each disclosed herein, will be described with reference to the drawings.

### (Evaluation of Semiconductor Products)

As semiconductor memories have become larger in capacity and more complex, an evaluation data size thereof has become larger and larger. The number of evaluation items required in order not to avoid failures in market has also increased significantly.

Thus, the volume of evaluation data required in development and mass production of semiconductor products such as semiconductor memory has become extremely large, and it has become difficult to store all the data in a fast-response storage (e.g., a hot storage). On the other hand, in order to ship semiconductor products and to guarantee their quality, past evaluation data may be required. Therefore, it is preferable to store evaluation data for certain period of time, and for this purpose, it has become necessary to utilize a storage having a relatively slow response time but a large capacity (e.g., cold storage).

The hot storage is a storage suitable for storing data that is frequently used and needs to be immediately accessible, and for example, storage devices such as Solid State Drives (SSDs), (semiconductor memories, semiconductor drive disks) are used. The cold storage is a storage suitable for storing data which needs to be stored for long periods of time but is not frequently used, and for example, storage devices such as Hard Disk Drives (HDDs) (magnetic disks), optical disks, magneto optical disks, and magnetic tapes, are used.

Moreover, inspections of semiconductor products are generally performed to be divided into a plurality of processes, such as a wafer inspection process for performing an electrical evaluation in a unit of wafer and a package inspection process for performing an electrical evaluation in a unit of package (integrated circuit (IC)) unit after the wafer is diced, divided into chips, and packaged. Since the number of chips on a wafer is extremely large, ranging from several hundred to several thousand, efficiency of the inspection can be improved when similar tests can be performed in a wafer inspection process at a previous stage rather than testing in an inspection process in a unit of IC. Therefore, a method has been reported for linking data from the plurality of inspection processes and conducting comprehensive analysis. In order to link and analyze the data from the plurality of inspection processes, evaluation data for the same chip is preferably managed in the same cold storage.

Furthermore, even when various evaluation data are stored in the storage, only some experts can freely utilize the stored evaluation data in the failure analysis. For already-known failures for which a failure analysis procedure has been known, it is general to systematize and automatically determine an analysis flow.

However, for unknown failures for which the failure analysis procedures are not known, it may be possible for non-experts to come close to the analysis performed by experts by referring to successful cases in which the experts searched, combined, and analyzed defect data from large amounts of data, and then allowing the non-experts to analyze the data.

Moreover, recently, big data is increasingly handled in various fields, not limited to semiconductor product evaluation data, and technologies such as computers, storage, and databases as environments for handling big data, as well as machine learning for making the most of big data, have been significantly developed. In database systems, it is common to store data search logs and to provide a function to totalize and analyze such logs. Moreover, a method has also been reported for using machine learning to promote more efficient operations.

Conventionally, evaluation data is moved to cold storage in order of oldest data on the basis of a date (e.g., time stamp) of evaluation data. Therefore, in order to extract target data to be used from the cold storage, it is necessary to find out a location of data (i.e., in which cold storage the data is stored) on the basis of the time stamp. Therefore, it is difficult to access the data immediately when needed.

Moreover, in an inspection that is divided into a plurality of processes, the inspection dates for each step may significantly differ from one another (e.g., differ in a unit of month). Therefore, when the inspection data for the plurality of processes is managed in separate storage, the data must be extracted from the individual storage for each process, which requires time and effort according to the number of processes. Furthermore, it takes a lot of time and effort to manually determine the storing destination storage on the basis of a data size, data relevance, storage availability, and the like.

Moreover, it is difficult for ordinary personnel except experts to analyze unknown failure data. Since the amount of data that an expert can analyze is limited, even when a large amount of evaluation data is acquired, it takes a very long time to analyze all of the acquired evaluation data.

### (Semiconductor Product Evaluation Data Management System)

A semiconductor product evaluation data management system, a semiconductor product evaluation data management method, and a semiconductor product evaluation data management program according to the embodiment, each include a data analysis program that models an expert's analytical procedure, and are configured to use the data analysis program to execute an automatic analysis of evaluation data, updating of a storage data index, movement ranking of the evaluation data to a storage, updating of a storing method of evaluation data in the storage, and the like. Consequently, it is possible to execute the data analysis and the data management similar to the experts.

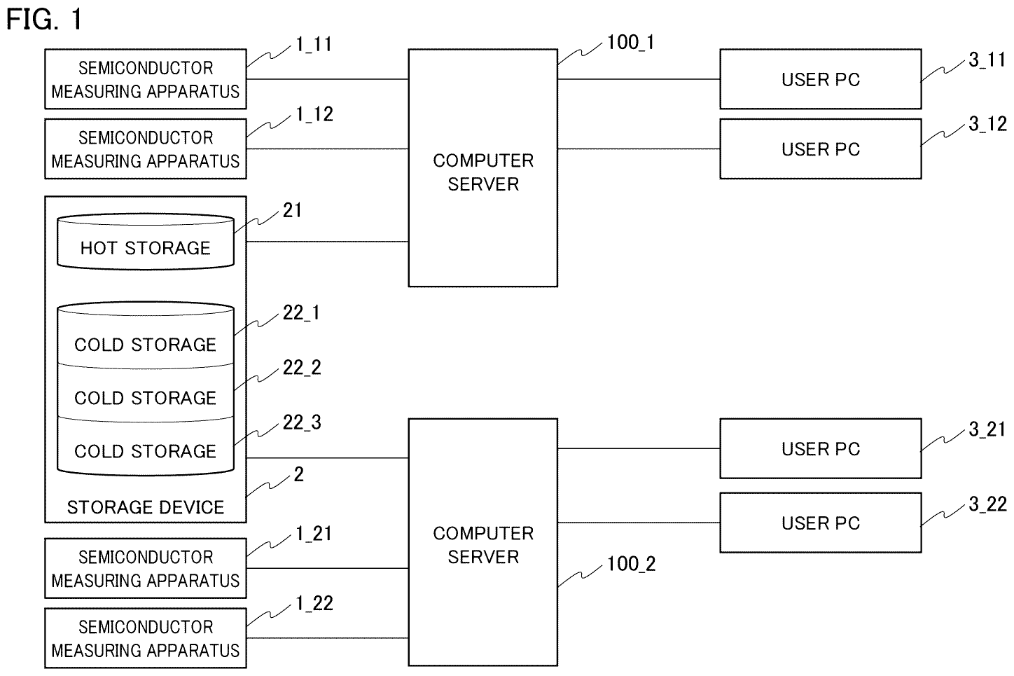

There will now be described the semiconductor product evaluation data management system, the semiconductor product evaluation data management method, and the semiconductor product evaluation data management program according to the embodiment, with reference to FIGS. 1 to 13. First, an environment of the semiconductor product evaluation data management system will be described, and then, a configuration of the semiconductor product evaluation data management system and a schematic function of each unit in the system will be described, and a processing flow of the semiconductor product evaluation data management system and the method thereof will further be described, with reference to flow charts and the like. The following description describes an example a semiconductor product evaluation data management system, a semiconductor product evaluation data management method, and a semiconductor product evaluation data management program used for an electrical evaluation in a manufacturing process of a semiconductor memories among various semiconductor products.

It is to be noted that part or all of the semiconductor product evaluation data management method described below can also be written in a computer-executable program (computer program) as instructions for the computer to be executed. The computer program is stored in, for example, a non-transitory computer readable medium and is used for the semiconductor product evaluation data management system according to the embodiment.

### (System Environment)

FIG. 1 illustrates an example of a system environment of a semiconductor product evaluation data management system configured to manage evaluation data of a semiconductor product. As illustrated in FIG. 1, the semiconductor product evaluation data management system includes

a computer server 100 (100_1, 100_2), a storage device 2 (21, 22_1, 22_2, 22_3), a semiconductor measuring apparatus 1 (1_11, 1_12, 1_21, 1_22), and a user Personal Computer (PC) 3 (3_11, 3_12, 3_21, 3_22). The computer server 100 is connected to the storage device 2, the semiconductor measuring apparatus 1, and the user PC 3, through a network.

In the example illustrated in FIG. 1, there are two computer servers 100_1, 100_2, four semiconductor measuring apparatus 1_11, 1_12, 1_21, 1_22, and four user PCs 3_11, 3_12, 3_21, 3_22, but the number of each apparatus is not limited to this example. The semiconductor product evaluation data management system according to the embodiment can include at least one computer server 100, and each computer server 100 can be connected to at least one semiconductor measuring apparatus 1 and at least one user PC 3.

Moreover, for example, the destination computer server 100 can be changed in accordance with a type of data, and in such a case, it may be configured so that the semiconductor measuring apparatus 1 is connected to a plurality of computer servers 100.

Moreover, in the example illustrated in FIG. 1, the storage device 2 includes one hot storage 21 and three cold storage 22 (22_1, 22_2, 22_3), but the number of each storage is not limited to this example. The storage device 2 can include at least one hot storage 21 and at least one cold storage 22.

Moreover, in the example illustrated in FIG. 1, the hot storage 21 and cold storages 22_1, 22_2, 22_3 are referred to collectively as the storage device 2 for the sake of explanation, but the hot storage 21 and cold storage 22 (22_1, 22_2, 22_3) are an independent and separate storage. For example, as above-described above, the hot storage 21 may be an SSD and the cold storage 22 (22_1, 22_2, 22_3) may be an HDD. Furthermore, the cold storages 22 (22_1, 22_2, 22_3) may be respectively independent and separate storages (e.g., magnetic disks, optical disks, magnetic tapes, or the like).

### (System Configuration)

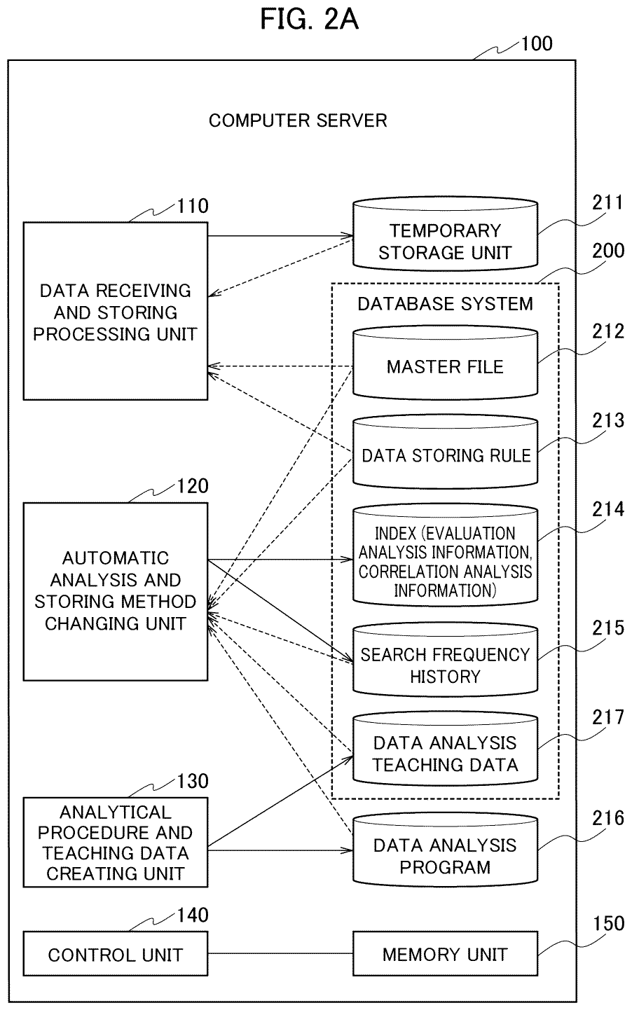

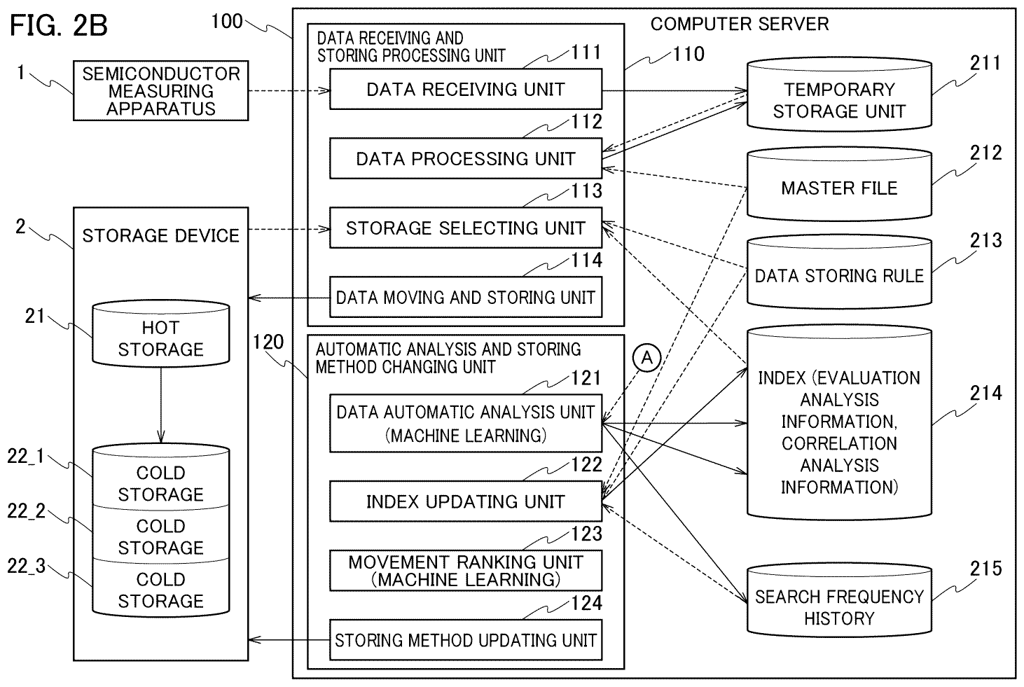

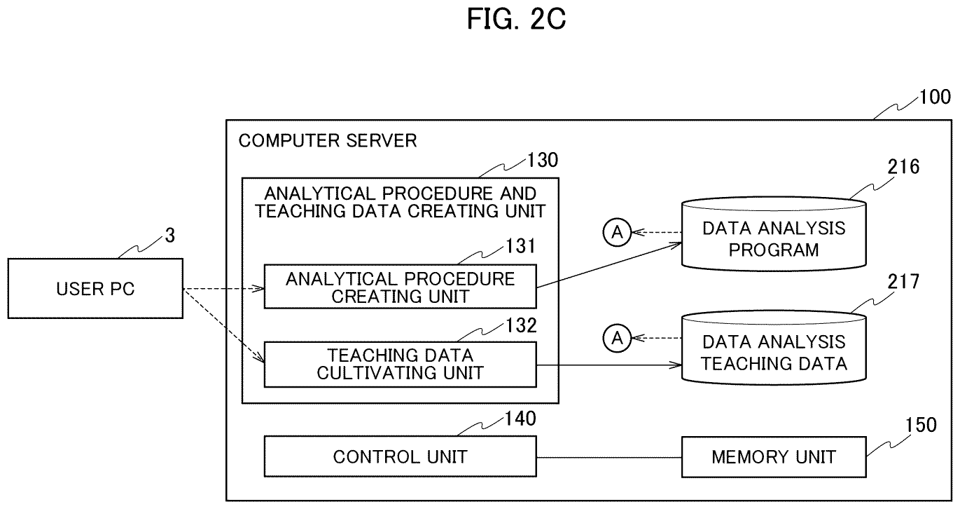

Next, a schematic system configuration of the semiconductor product evaluation data management system according to the embodiment will be described. FIG. 2A illustrates a schematic internal block configuration of the computer server 100 according to the embodiment. FIGS. 2B and 2C illustrate a block configuration of the semiconductor product evaluation data management system. Due to space limitation of drawing sheets, the block configuration of the semiconductor product evaluation data management system is illustrated across two drawing sheets, i.e., FIGS. 2B and 2C. Herein, one of the computer servers 100_1 and 100_2 illustrated in FIG. 1 will be described as a representative example of the computer server 100. The computer server 100 described herein is connected to one semiconductor measuring apparatus 1, one user PC 3, and the storage device 2 including one hot storage 21 and three cold storage 22 (22_1, 22_2, 22_3) through a network.

The semiconductor product evaluation data management system according to the embodiment includes a data receiving and storing processing unit 110, an automatic analysis and storing method changing unit 120, an analytical procedure and teaching data creating unit 130, and a control unit 140. The semiconductor product evaluation data management system further includes a temporary storage unit (i.e., data temporary storage location) 211, a master file 212, a data storing rule 213, a storage data index 214, a search frequency history 215, a data analysis program 216, data analysis teaching data 217, and a memory unit 150. The database system 200 is composed including a temporary storage unit 211, a master file 212, a data storing rule 213, a storage data index 214, a search frequency history 215, and data analysis teaching data 217.

The data receiving and storing processing unit 110 includes a data receiving unit 111, a data processing unit 112, a storage selecting unit 113, and a data moving and storing unit 114.

The automatic analysis and storing method changing unit 120 includes a data automatic analysis unit (machine learning) 121, a storage data index updating unit 122, a data movement ranking unit (machine learning) 123, and a storing method updating unit 124.

The analytical procedure and teaching data creating unit 130 includes an analytical procedure creating unit 131 and a teaching data cultivating unit 132.

The control unit 140 executes a semiconductor product evaluation data management program according to the embodiment stored in the memory unit 150 to execute each processing described below. The memory unit 150 is, for example, a read-only memory for data. The memory unit 150 may be, for example, a non-transitory computer-readable recording medium for storing a computer program. The control unit 140 executes the computer program stored in the memory unit 150 to execute various processing illustrated in each flow chart described below.

As a schematic configuration example, the semiconductor product evaluation data management system according to the embodiment includes a computer server 100 configured to manage evaluation data of semiconductor product, and a plurality of storage devices 2 (21, 22_1, 22_2, 22_3) configured to store the evaluation data. The computer server 100 includes a storage data index 214 configured to store an index attached to evaluation data stored in the computer server 100 and the plurality of storage devices 2 (21, 22_1, 22_2, 22_3), a storage data index updating unit 122 configured to store and update manufacturing information of semiconductor product in the index, and a storing method updating unit 124 configured to control movement of evaluation data to the specific storage device 22 (22_1, 22_2, 22_3) among the plurality of storage devices 2 (21, 22_1, 22_2, 22_3) in a unit of manufacturing information of semiconductor product in accordance with the index.

The manufacturing information of semiconductor product and the evaluation analysis information of semiconductor product may be stored in the above-described index. The storing method updating unit 124 may be configured to control movement of the evaluation data to the specific storage device 22 in a unit of the manufacturing information in accordance with an evaluation analysis result, a search frequency of the evaluation data, a data size of the evaluation data, and availability of the storage device 2.

Alternatively, the evaluation analysis information of semiconductor product and correlation analysis information of the evaluation data in a plurality of inspection processes may be stored in the above-described index. The storing method updating unit 124 may be configured to control the movement of the evaluation data to the specific storage device 22 in a unit of the manufacturing information in accordance with the evaluation analysis result, the search frequency of the evaluation data, the data size of evaluation data, the correlation analysis information of the evaluation data in the plurality of inspection processes, and the availability of the storage device 2.

Furthermore, it is also possible to provide the data movement ranking unit 123 configured to execute machine learning using input of the evaluation analysis result, the search frequency of the evaluation data, the data size of the evaluation data, the correlation analysis information of the evaluation data over the plurality of inspection processes, and the availability of the storage device 2, to calculate priority for moving the evaluation data to the specific storage device 22 (22_1, 22_2, 22_3).

Moreover, the plurality of storage devices 2 (21, 22_1, 22_2, 22_3) includes with hot storage 21 and cold storage 22 (22_1, 22_2, 22_3), and the storing method updating unit 124 can also move the evaluation data stored in the hot storage 21 to the cold storage 22 (22_1, 22_2, 22_3) in accordance with the index.

The above-described index further includes a storing flag for storing the evaluation data in the hot storage 21 in a unit of the manufacturing information, the storage data index updating unit 122 may also be configured to update the storing flag with reference to a predetermined storing rule, and the storing method updating unit 124 may also be configured to exclude evaluation data to which the storing flag is attached from data to be moved to the cold storage 22 (22_1, 22_2, 22_3).

Herein, for example, as an example of the “unit of manufacturing information” is a unit of lot, and other examples of the “unit of manufacturing information” are a unit of product, a unit of shipping destination of wafer, a unit of process, and the like.

### (1. Internal Configuration of Semiconductor Product Evaluation Data Management System)

Hereinafter, there will be described a schematic configuration inside the semiconductor product evaluation data management system according to the embodiment.

### (1.1 Configuration of Data Receiving and Storing Processing Unit)

A configuration of the data receiving and storing processing unit 110 regarding receiving and storing of measured data will now be described. The data receiving and storing processing unit 110 is configured to receive and process measured data for each inspection process measured by the semiconductor measuring apparatus 1 from the semiconductor measuring apparatus 1, to select a specific storage that stores evaluation data which is the result of processing from the storage devices 21, 22_1, 22_2, 22_3, and to store the aforementioned data in the selected specific storage.

More specifically, the measuring apparatus 1 measures electrical characteristics and the like of a semiconductor which is a semiconductor product, and transfers a measured result file (i.e., measured data) to the computer server 100. The data receiving unit 111 in the computer server 100 receives the measured result file, and stores the received file in a temporary storage unit (i.e., data temporary storage location) 211. The data processing unit 112 executes predetermined data processing for the measured result file in accordance with a type of the measured result file, and stores evaluation analysis information (i.e., evaluation data) which is a data processing result in the temporary storage unit (i.e., data temporary storage location) 211. The storage selecting unit 113 selects a specific storage for storing the measured data in accordance with a data storing rule 213 in the computer server 100 from the storage device 21, 22_1, 22_2, or 22_3. The data moving and storing unit 114 moves/stores data from the temporary storage unit 211 to/in the specific storage device 2 (e.g., hot storage 21 or cold storage 22_1, 22_2, or 22_3) determined by the storage selecting unit 113, and registers information on the specified storage as storing destination in the storage data index 214.

### (1.2 Configuration of Data Automatic Analysis and Storing Method Changing Unit)

Next, a configuration regarding the automatic analysis and storing method changing unit 120 will be described. The automatic analysis and storing method changing unit 120 is configured to conduct a correlation analysis of the data over a plurality of inspection processes, and to change a storing method of the data to the storage device 2 (21, 22_1, 22_2, 22_3) on the basis of an analysis result thereof.

More specifically, the data automatic analysis unit 121 calculates a correlation coefficient by reading product information and evaluation data over the plurality of inspection processes and analyzes a tendency of the evaluation data. The storage data index updating unit 122 registers, in the storage data index 214, data search frequency ranking for each product lot, a total data size, a totalized value of the correlation coefficient, and a movement priority to the cold storage. The data movement ranking unit 123 reads information on the manufacturing information, the data size, the search frequency ranking, and the totalized value of the correlation coefficient registered in the storage data index 214, and calculate the movement priority from the hot storage 21 to the cold storages 22_1, 22_2, 22_3 through Learning To Rank by machine learning. The storing method updating unit 124 collectively moves the evaluation data over the plurality of inspection processes stored in the hot storage 21 to the cold storages 22_1, 22_2, 22_3.

### (1.3 Configuration of Analytical Procedure and Teaching Data Creating Unit)

Next, a configuration regarding the analytical procedure and teaching data creating unit 130 will be described. The analytical procedure and teaching data creating unit 130 is configured to create a program obtained by modeling a data analysis procedure and to cultivate teaching data.

In the analytical procedure and teaching data creating unit 130, the analytical procedure creating unit 131 extracts information obtained by searching, linking and analyzing failure data by the expert from the data analysis teaching data 217 and the like in the database system 200, to organize the analytical procedure, an evaluation item, and the product information of the target data, and to create the data analysis program 216. The teaching data cultivating unit 132 uses the analysis data that has been checked for correctness, cultivates the teaching data of the machine learning model, and reflects the cultivated teaching data in the data analysis teaching data 217.

### (2. Processing Operation of Semiconductor Product Evaluation Data Management System)

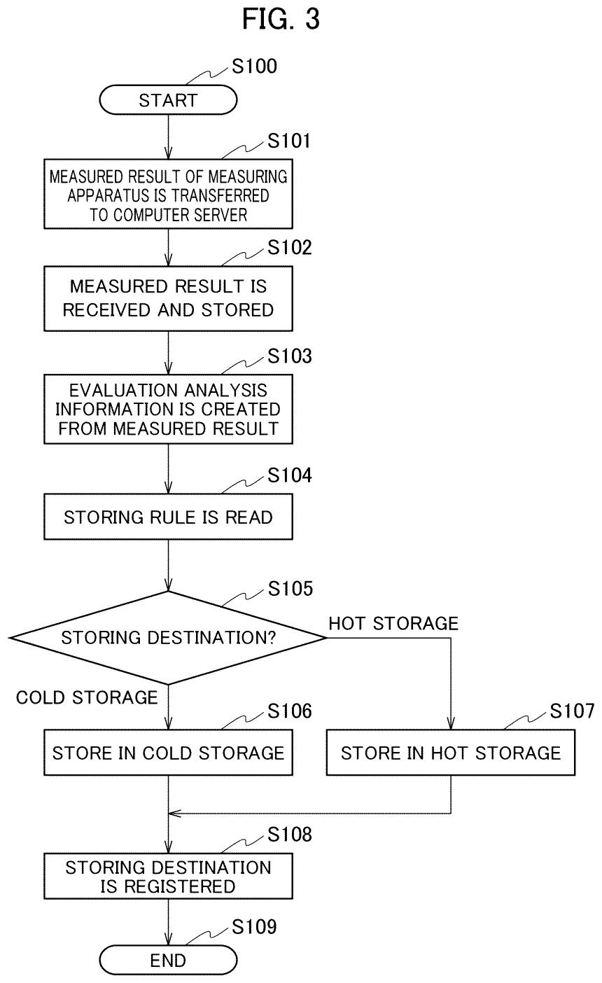

Next, a processing operation of the semiconductor product evaluation data management system and a processing flow of the semiconductor product evaluation data management method will be described, with reference to the flow charts and various explanatory diagrams illustrating in FIGS. 3 to 13. It is to be noted that part or all of the semiconductor product evaluation data management method described below can also be written in a computer-executable program (e.g., computer program) as instructions for the computer to be executed. The computer program is stored in, for example, a non-transitory computer readable medium and is used for the semiconductor product evaluation data management system according to the embodiment.

### (2.1 Operation of Data Receiving and Storing Processes)

FIG. 3 illustrates a processing example executed by the data receiving and storing processing unit 110 in the semiconductor product evaluation data management method according to the embodiment. The process flow illustrated in FIG. 3 is executed, for example, whenever the measuring apparatus 1 measures the semiconductor product and transfers the measured result as a measured result file (i.e., measured data) to the computer server 100 (Step S100).

In Step S101, the measuring apparatus 1 measures a semiconductor product and transfers a measured result file (i.e., measured data) to the computer server 100.

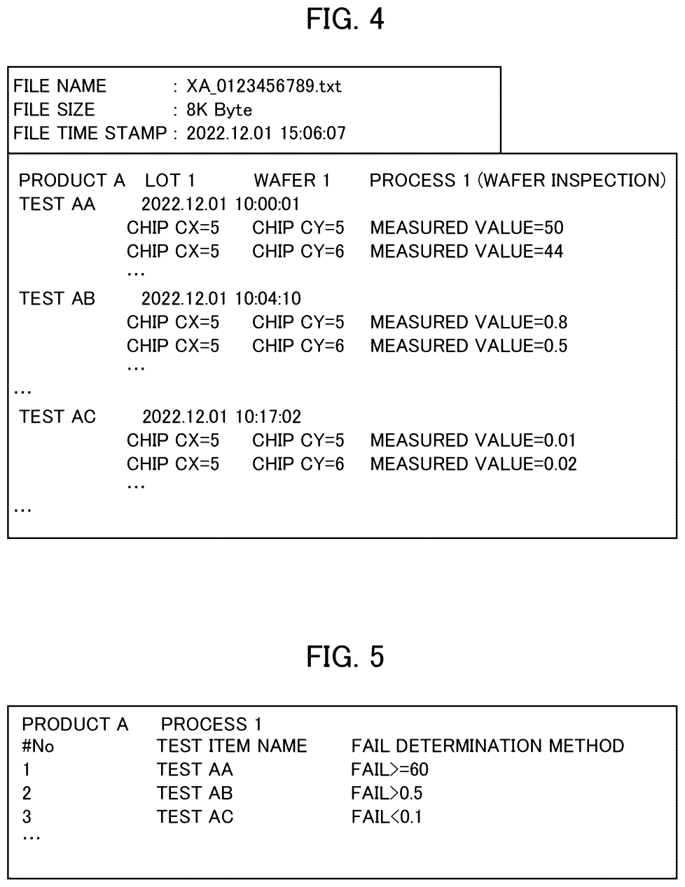

FIG. 4 illustrates an example of the measured result file. A file name of the measured result file illustrated in FIG. 4 is “XA_0123456789.txt”, a file size is “8K byte” (8 kilobytes), and a file time stamp is “December 1, 2022, 15:06:07”. In a data portion of the measured result file, a product name (“product A”) of the measured semiconductor product, a lot number (“lot 1”) and a wafer number (“wafer 1”) which are fabricating unit information, and an inspection process name (“process 1 (wafer inspection)”) are written in the first line. In addition to the above-described information, information on the measuring apparatus 1 may further be written. A test item name “test AA” and a starting date and time of measurement (“December 1, 2022, 10:00:01”) are written in the second line of the data portion, and a measurement value for each chip address (X, Y) is written in the third and subsequent lines. In present embodiment, the information on the plurality of test items is collectively written in one file. The measuring apparatus 1 transfers the measured result file to the computer server 100. Various measurement items may be supposed as a specific measurement item depending on the type of semiconductor element to be produced and a difference between processes thereof, etc., for example, regarding an actual semiconductor element, there are an open/short circuit, an input/output terminal leakage, etc. as a direct current (DC) test, and there are alternating current (AC) characteristics etc. as an alternating current (AC) test. Moreover, regarding Test Elementary Group (TEG), there are transistor characteristics, a contact resistance, a wiring open/short circuit, and the like.

In Step S102, the data receiving unit 111 in the computer server 100 receives the measured result file and stores the received file in the data temporary storage location in the computer server 100.

In Step S103, the data processing unit 112 reads the measured result file from the temporary storage unit 211 and executes predetermined data processing in accordance with the type of the measured result file. More specifically, the data processing unit 112 reads the measured result file from the temporary storage unit 211 in accordance with an instruction from the user PC(s) 3 and executes the predetermined data processing in accordance with the type of measured result file to create, for example, evaluation analysis information and the like. The user PC(s) 3 can refer to and analyze the evaluation analysis information and the like which are a result of the predetermined processing executed by the data processing unit 112.

Herein, the “type of the measured result file” includes, for example, characteristic data file obtained by measuring a current of each component of the semiconductor product to be measured, a fail bit data file which is a result of determining pass/fail of each bit in a unit of a memory cell of the semiconductor memory, and the like. The “predetermined data processing” to be executed for each the “type of the measured result file” includes, for example, data processing to register characteristic data for each type of the measured result file, data processing to create a fail bit map on the basis of the fail bit data, and the like.

In general, in order to shorten a test time in the semiconductor measuring apparatus 1, a contrivance is built to shorten the time required to write the measured result in the file. An example of the contrivance is to use binary files or hexadecimal numbers. These data are transferred to the computer server 100 and then processed before being read out. There is also a data processing program that executes a unit conversion, an address conversion according to a physical layout, addition of information, including failure mode classification, and the like, after being transferred to the computer server 100.

FIG. 5 illustrates an example of data of the master file 212 used in the data processing executed by the data processing unit 112. In the data of the master file 212, a test execution order and a measurement value specification are described. A product name (“product A”) and an inspection process name (“process 1”) of the semiconductor product to be measured are listed in the first line. A test execution order (#No), a test item name, and a fail determination method such as a fail determination threshold value are listed in the third and subsequent lines. In the third line, the test execution order is “first”, the test item name is “Test AA”, and the fail determination threshold value is “Fail>=60” (when the measured value is 60 or more, a fail is determined). In the case of the above-described FIG. 4, for the first chip address “chip CX=5, CY=5”, the test AA has “measured value=50”, the test AB has “measured value=0.8”, and the test AC has “measured value=0.01”, and as a result of being processes using the master file 212 illustrated in FIG. 5, the test AA is determined to be “Pass”, the test AB is determined to be “Fail”, and the test AC is determined to be “Fail”. Then, in consideration of the test execution order, the test AB determined firstly to be “Fail” is set as the failure classification of the aforementioned chip (i.e., chip CX=5, CY=5).

The data in the master file 212 can also be stored in the temporary storage unit 211 and read into internal memory such as a memory unit 150 for use.

In this way, the data processing unit 112 determines whether “Pass or Fail” and the failure classification for each chip to be measured.

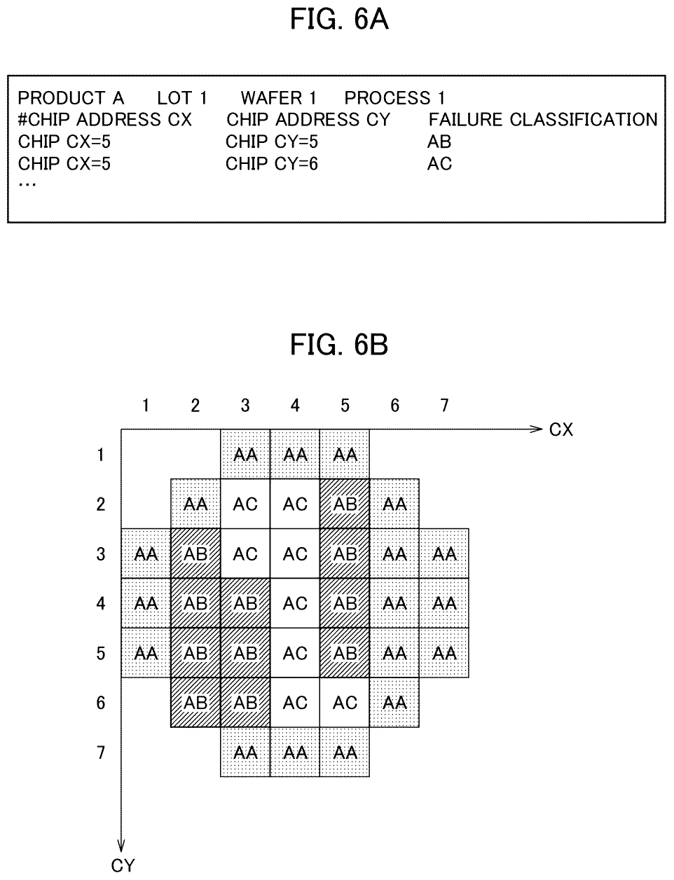

FIG. 6A illustrates an example of a determination result of failure classification for each chip by the data processing unit 112. FIG. 6B illustrates an example of a failure classification for each chip represented on a wafer map. In the example illustrated in FIG. 6B, it can be seen that the same failures have occurred in each area, such as an outer peripheral portion and a center portion of the wafer due to the cause of the failure occurrence, resulting in a wafer map where the failure classification is biased for each area.

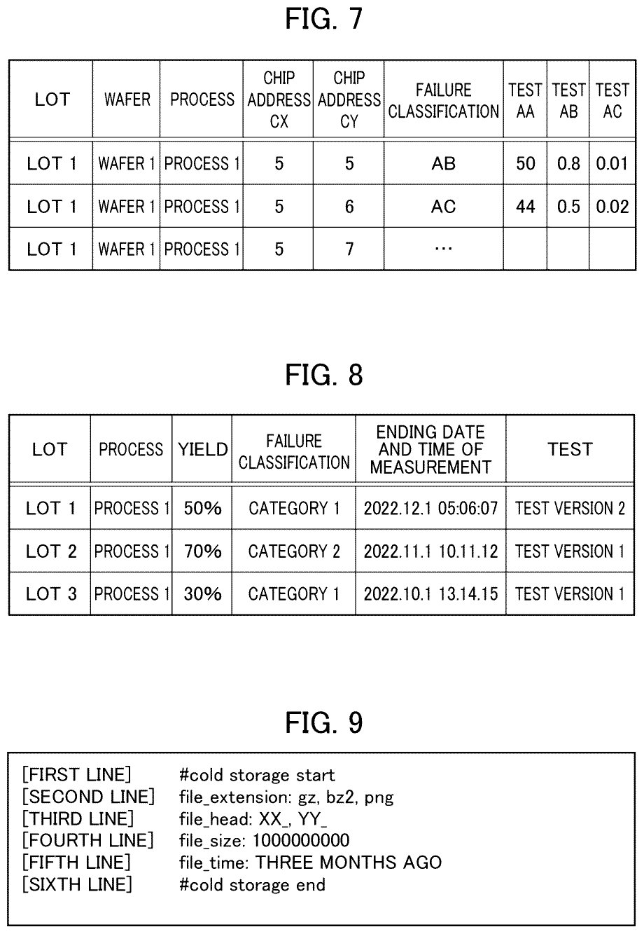

FIG. 7 illustrates an example of evaluation analysis information (unit of chip) by the data processing unit 112, which illustrates information on a lot, a wafer, a chip, and a process which are fabricating unit information, and a failure classification for each chip and a measured result for each test item. FIG. 8 illustrates an example of evaluation analysis information (unit of lot) by the data processing unit 112, which illustrates information on a yield, a failure classification, and a test in a unit of lot. The evaluation analysis information (i.e., the evaluation analysis information (unit of chip) illustrated in FIG. 7 and the evaluation analysis information (unit of lot) illustrated in FIG. 8) is temporarily stored in the temporary storage unit 211. A part or collected information on the evaluation analysis information temporarily stored in the temporary storage unit 211 is then stored in the storage data index 214.

Returning to FIG. 3, the storage selecting unit 113, in Step S104, reads the data storing rule 213, and in Step S105, determines a specific storage (e.g., storage 21, 22_1, 22_2, or 22_3) for storing the evaluation data in accordance with the read data storing rule 213.

FIG. 9 illustrates an example of the data storing rule 213. Conditions for the evaluation data to be stored (moved) to the cold storages 22_1, 22_2, 22_3 are listed between “#cold storage start” in the first line and “#cold storage end” in the sixth line. When a plurality of conditions are listed, the condition listed on the upper line shall take precedence.

A file extension is listed in “file_extension:” in the second line. When a plurality of the file extensions are listed, they should be separated by commas. In the example in FIG. 9, compressed file extensions (gz, bz2) and an image file extension (png) are listed. A file(s) having the extension listed herein is stored in the cold storages 22_1, 22_2, 22_3.

An initial character of the file name is listed in “file_head:” in the third line. When a plurality of the file names are listed, they should be separated by commas. In the example in FIG. 9, “XX_” is listed as the initial character of the file name. Therefore, for example, a file having a file name of “XX_1234567.txt” is stored in the cold storages 22_1, 22_2, 22_3 since beginning of three characters of the file name conforms to “XX_”.

One file size is described in “file_size:” in the fourth line. In this case, since “1000000000” is listed, a file(s) equal to or greater than 1 G byte (1 gigabyte) is stored in the cold storages 22_1, 22_2, 22_3.

One piece of information for specifying a data date (time stamp) is listed in “file_time:” in the fifth line. In the example in FIG. 9, since “three month ago” is listed, data having a time stamp of of three months or more ago is stored in the cold storages 22_1, 22_2, 22_3.

Suppose that the computer server 100 receives the measured result file illustrated in FIG. 4 immediately after measurement performed by the measuring apparatus 1 (for example, Dec. 1, 2022). In the measured result file illustrated in FIG. 4, since the file extension is “txt”, it does not conform to the “file_extension:” in the second line of the data storing rule 213 illustrated in FIG. 9. Moreover, in the measured result file illustrated in FIG. 4, since the beginning of three characters of the file name is “XA_”, it does not also conform to the “file_head:” in the third line of the data storing rule 213 illustrated in FIG. 9. Moreover, in the measured result file illustrated in FIG. 4, since the file size is “8K Byte”, it does not also conform to the “file_size:” in the fourth line of the data storing rule 213 illustrated in FIG. 9. Supposing that the selecting process date of storing destination storage by the storage selecting unit 113 is December 1, 2022, the same day as the measurement date, it does not also conform to the “file_time:” in the fifth line of the data storing rule 213 illustrated in FIG. 9. From the above, since it does not conform to all data storing rule 213 for being moved to the cold storage, the storage selecting unit 113 selects the hot storage 21 as the storing destination of the measured result file illustrated in FIG. 4 (Step S107).

It is to be noted that, in the measured result file of FIG. 4, the hot storage 21 is selected as the storing destination since all conditions do not conform to the data storing rule 213 of FIG. 9, but when at least one condition conforms to the data storing rule 213, the storage selecting unit 113 selects the cold storage 22 (22_1, 22_2, 22_3) as the storing destination (Step S106).

Returning to FIG. 3, in Step S108, the data moving and storing unit 114 moves the evaluation data from the temporary storage unit 211, stores the moved evaluation data in the storing destination selected by the storage selecting unit 113, and further registers the information on the storing destination in the storage data index 214. Subsequently, the series of processing is ended (Step S109).

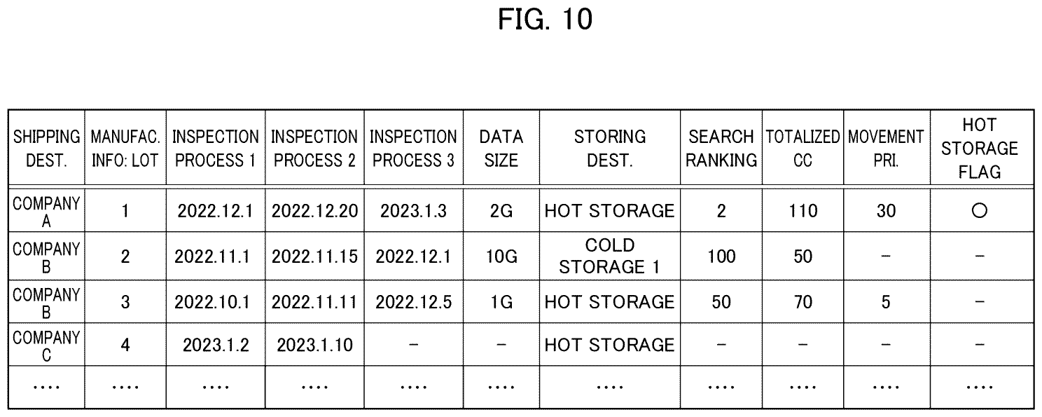

FIG. 10 illustrates an example of the storage data index 214. The storage data index includes a shipping destination, a lot information which is one of the fabricating units, and a date of being stored in the storage device 2 for each inspection process, a total data size of all inspection processes, storing destination storage information, search frequency ranking, a totalized value of correlation coefficient, a movement priority to the cold storage, and a data storing continuation flag to the hot storage (i.e., hot storage storing flag). The data size, search frequency ranking, the totalized value of correlation coefficient, the movement priority to the cold storage, and the hot storage storing flag are registered and updated when updating the storage storing method described below.

### (2.2 Operation of Automatic Analysis and Storing Method Changing Process)

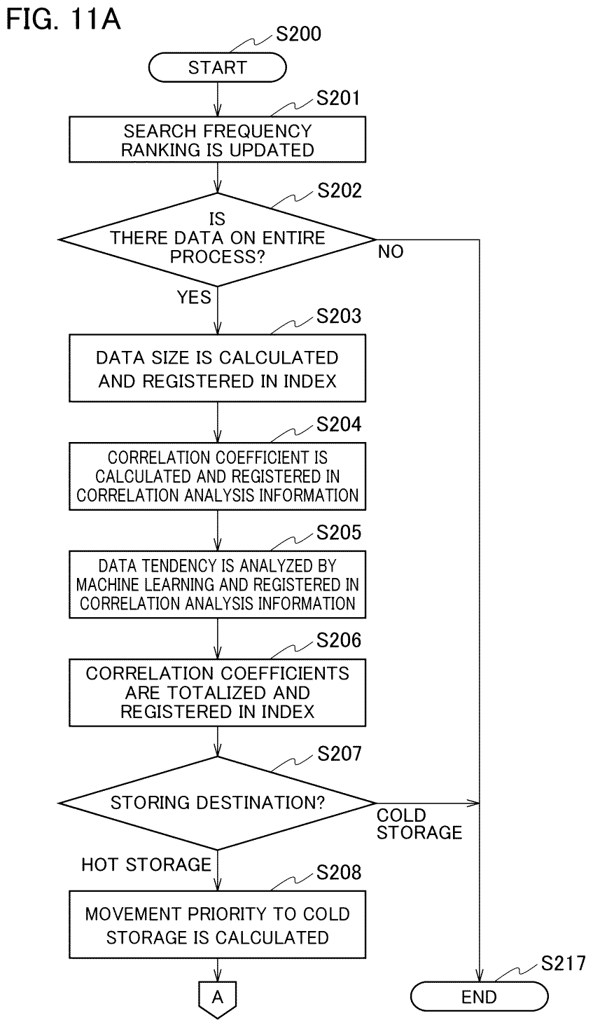

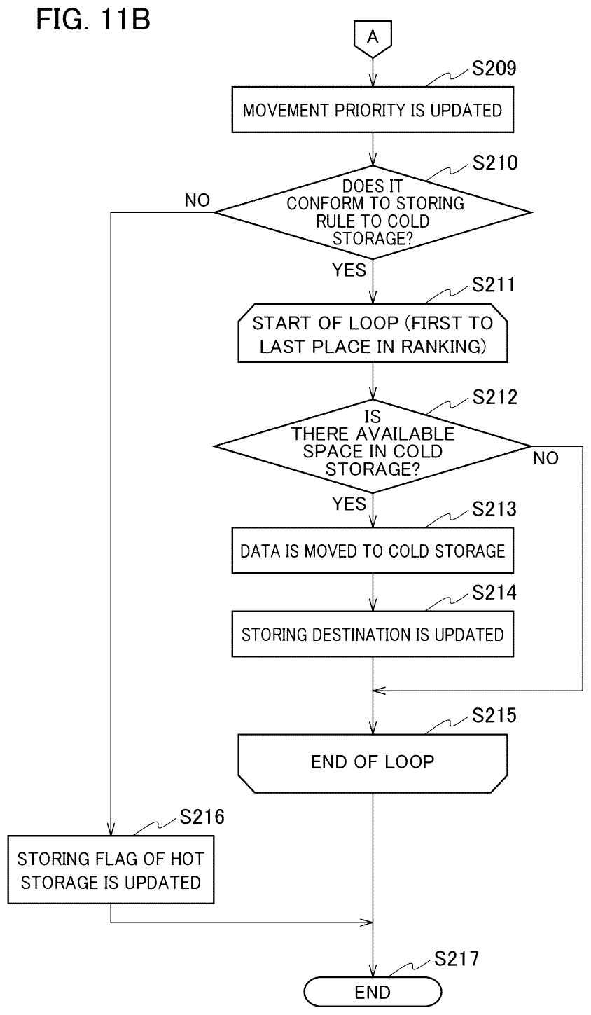

FIGS. 11A and 11B illustrate an outline flowchart of processing executed by the automatic analysis and storing method changing unit, in the semiconductor product evaluation data management method according to the embodiment. This process flow is executed periodically, for example, once a week (Step S200).

In FIG. 11A, the storage data index updating unit 122 updates a search frequency ranking in the storage data index 214 with reference to a data search frequency history in the search frequency history 215, in Step S201. The data search frequency history can be automatically counted from, for example, a search log by a count program or the like. Alternatively, a multifaceted count can be executed for such as a search frequency history for each user, a search frequency history for each period, and a search frequency history for each evaluation data.

If the data of all inspection processes (e.g., inspection processes 1-3 in the example of FIG. 10) is not complete for each line of data (i.e., for each lot) in the storage data index 214 (NO in Step S202), the storage data index updating unit 122 terminates the processing (Step S217).

If the data of all inspection processes is complete (YES in Step S202), the storage data index updating unit 122 calculates a total size of all inspection processes and registers the calculated total data size as the data size in the storage data index 214 in Step S203.

Next, in Step S204, the data automatic analysis unit 121 reads data of the plurality of processes (e.g., a wafer inspection process and a package inspection process) into the data analysis program to calculate a correlation coefficient, and registers the calculated correlation coefficient to the correlation analysis information in the storage data index 214. Furthermore, in Step S205, the data automatic analysis unit 121 analyzes a data tendency of the plurality of processes by machine learning obtained by modeling the expert's analysis to calculate a correlation coefficient, and registers the calculated correlation coefficient in the correlation analysis information in the storage data index 214.

As the “data analysis program” used herein, for example, a program for a general statistical method can be used. As the statistical method used herein, there are, for example, one-to-one correlation (Pearson correlation coefficient, Spearman correlation coefficient), regression analysis (simple regression analysis, multiple regression analysis (statistical method to investigate a relationship between a result numerical value and a factor numerical value and clarify the relationship therebetween)), classification analysis (supervised machine learning, Multi-Layer Perceptron (MLP)), and the like. However, the present embodiment is not limited to a specific type of statistical method or a specific type of data analysis program.

As an example of the “correlation coefficient” calculated in Steps S204 and S205, it is determined whether there is a numerical relationship between a leakage current value in the test item A in the wafer inspection process and a leakage current value in the test item B in the package inspection process, in a unit of chip. The package inspection is relatively expensive since each chip is inspected individually, whereas the wafer inspection is relatively inexpensive since chips on a wafer are collectively inspected. When a stable high correlation can be obtained, the test item B of the package inspection process can be reduced (or omitted) by executing the test item A of the wafer inspection process.

Moreover, the following is assumed as a simple example of the “machine learning obtained by modeling the expert's analysis” used in Step S205. Namely, the leakage current value in the test item A is read, and a correct answer, such as when it is “99999”, it is excluded because the measurement is abnormal, when it is “within a range of 0 to 0.01 A”, it is normal, and when it is “exceeds 0.01 A”, it is abnormal, is provided to learn, and thereby reference (teaching) data for performing determination similarly to analysis experts is created. Furthermore, the teaching data can also be created by combining a plurality of conditions. in “supervised machine learning”, the accuracy and efficiency of analysis can be increased by reading large amounts of data on the basis of determination of the analysis experts.

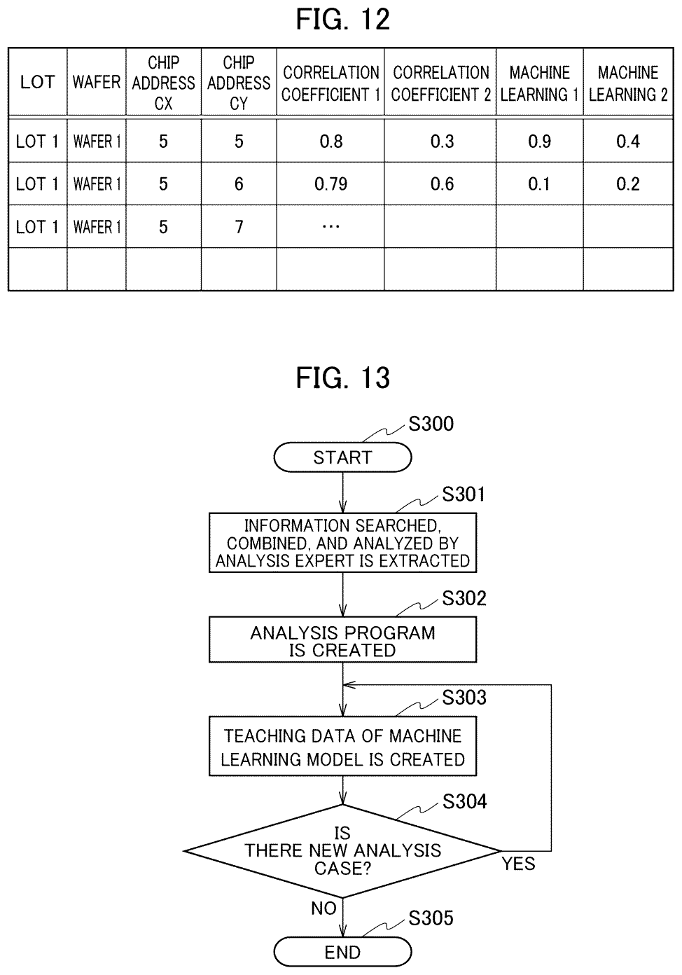

FIG. 12 illustrates an example of correlation analysis information (in unit of chip) over a plurality of processes. In this example, the correlation analysis information includes two correlation coefficients, correlation 1 and correlation 2, and a coefficient obtained by analyzing the tendency for each chip by the machine learning 1 and the machine learning 2.

Returning to FIG. 11A, after the data automatic analysis unit 121 registers the correlation analysis information, the storage data index updating unit 122, in Step S206, totalizes the correlation analysis information as exemplified in FIG. 12 in the unit of lot and registers the totalized result in the totalized value of correlation coefficient in the storage data index 214.

Subsequently, in Step S207, with reference to the storing destination in the storage data index 214, when the storing destination is the cold storage 22, the processing is ended (Step S217), and when the storing destination is the hot storage 21, the processing proceeds to Step S208.

In Step S208, the data movement ranking unit 123 reads information on the data size, the search frequency, and the totalized value of correlation coefficient regarding a lot of which the storing destination is the hot storage in the storage data index 214, and calculates movement priority of 22 to the cold storage through the Learning To Rank (LTR) by the machine learning.

The “Learning To Rank by the machine learning” used herein is a machine learning method for ordering information on the basis of a defined importance score.

As an example of the order of calculating the “movement priority” from the “information on the data size, the search frequency, and the totalized value of the correlation coefficient”, the order of the importance score can also be defined as follows: (1) totalized value of correlation coefficient (the higher the value, the more important); (2) search frequency (the more searches, the more important), (3) data size (the smaller the data size, the easier to move; the larger the data size, the harder to move). For example, when the data size is the same, the priority is given to the one with the smaller number of searches, and when the number of searches is the same, the priority is given to the one with the smaller data size.

Moving to FIG. 11B, next, in Step S209, the storage data index updating unit 122 updates the movement priority in the storage data index 214 on the basis of a result calculated in Step S208.

Next, in Step S210, the storage data index updating unit 122 determines whether it conforms to the storing rule to the cold storage 22 with reference to the data storing rule 213.

As a result of the determination in Step S210, when it does not conform to the storing rule to the cold storage 22 (NO in Step S202), the storage data index updating unit 122 updates the hot storage storing flag in the storage data index 214 in Step S216. Data in which the hot storage storing flag is set to ON (marked with the “white round mark” in the example illustrated in FIG. 10) is excluded from the data to be moved to the cold storage 22. For example, supposing that the executing date of this processing operation is Apr. 1, 2023, the “file_time: three months ago” is described in the data storing rule 213 illustrated in FIG. 9 and the time stamp “January 3, 2023” of the process 3 for the lot 1 illustrated in FIG. 10 does not conform to the “three months ago”, and therefore “white round mark” is marked in the hot storage storing flag to be excluded from the data to be moved to the cold storage 22. Subsequently, the processing is ended (Step S217).

As conditions for “excluded from the data to be moved to the cold storage 22”, the “file_size” (i.e., file size) and the “file_time” (i.e., time stamp) which are items that may fluctuate are listed in the example illustrated in FIG. 9. When it conforms to at least one of the rules listed in the data storing rule 213, it is excluded from the data to be moved to the cold storage 22.

Next, in Steps S211 to S215, the moving processing of conforming data to the cold storage 22 is executed. Namely, the processing in Steps S212 to S214 is repeated with respect to the lots having the movement priorities within a range from a first place to a last place in the storage data index 214.

In Step S212, the storing method updating unit 124 confirms whether the cold storage 22 (22_1, 22_2, 22_3) has available space equal to or greater than the data size of the lot data to be moved. As a result of determination in Step S212, when the cold storage 22 has available space, the storing method updating unit 124, in Step S213, moves collectively the data of a plurality of processes to the cold storage 22 (22_1, 22_2, 22_3). Then, in Step S214, the storage data index updating unit 122 updates the storing destination information in the storage data index 214 to information of the destination cold storage 22 (22_1, 22_2, 22_3). Then, the similar processing is executed for the data of the next ranked lot.

As a result of determination in Step S212, when there is no available space in the cold storage 22, the processing of Steps S213 and S214 is skipped, and the similar processing is executed for the data of the next ranked lot.

When the processing in Steps S212 to S214 is completed for lots having the movement priorities within the range from the first place to the last place in the storage data index 214, the processing is ended (Step S217).

### (2.3 Operation of Analytical Procedure and Teaching Data Creation Process)

FIG. 13 is an outline flowchart of processing executed by the analytical procedure and teaching data creating unit 130, in the semiconductor product evaluation data management method according to the embodiment. This process flow is executed irregularly in accordance with progress of an analysis by an expert, for example (Step S300).

In Step S301, the analytical procedure creating unit 131 extracts information obtained by an expert searching, linking and analyzing failure data, from the data analysis teaching data 217 and the like in the database system 200. The information obtained by the expert searching, linking and analyzing failure data is stored (registered) in the data analysis teaching data 217 by the data analysis program 216.

In Step S302, the analytical procedure creating unit 131 organizes the analytical procedure, the evaluation item, and the product information of target data, creates the data analysis program 216 to be stored in the computer server 100. The data analysis program 216 is created as a format that uses machine learning models, such as regression, in accordance with the purpose, and processes product information as input arguments.

In Step S303, the teaching data cultivating unit 132 uses the analysis data that has been checked for correctness, cultivates the teaching data of the machine learning model, and reflects the cultivated teaching data in the data analysis teaching data 217. The teacher data can be created by a system administrator or others using analysis cases that has been checked for correctness.

Then, in Step S304, when there is another new analysis case, the processing returns to Step S303 and the teaching data cultivation processing is repeated. In Step S304, when there is no new analysis case, the processing is ended (Step S305).

Since there are so many evaluation items in semiconductor product evaluation, non-experts sometimes may not know which evaluation items to use as objective and explanatory variables for analysis. Therefore, the embodiment adopts a format where the expert's analytical procedure is incorporated into the data analysis program also including the evaluation item names and the manufacturing information is read and processed as the argument. This data analysis program is used in the data automatic analysis unit 121, in which the manufacturing information is switched and a large amount of data is automatically analyzed, thereby analyzing the tendency of the evaluation data.

Herein, the “objective variable” is a variable (Y) that results from the influence of a factor, and the “explanatory variable” is a variable (X) of an influencing factor, for example, Y=aX+b. The “format where the expert's analytical procedure is incorporated into the data analysis program also including the evaluation item names and the manufacturing information is read and processed as the argument” used herein means, for example, that the system administrator first understands the expert's analysis procedure, and then understands, for example, the format of the evaluation data to be used, the names of evaluation items, the data units, the method of data registration, the method of determining pass/fail, etc. When there are a plurality of procedures at that time, those procedures are summarized in a flow.

### (Storage Medium for Storing Semiconductor Product Evaluation Data Management Program)

The program executable by a computer (computer program) as instructions for causing a computer to execute a part or all of the semiconductor product evaluation data management method is stored in, for example, a non-transitory computer readable medium and is used for the semiconductor product evaluation data management system according to the embodiment.

The semiconductor product evaluation data management program according to the present embodiment can be executed by a computer used for the semiconductor product evaluation data management system including a computer server configured to manage the evaluation data of the semiconductor product and the plurality of storage devices configured to store the evaluation data. In the computer server, the computer is caused to execute: a procedure of storing and updating, by the storage data index updating unit, the manufacturing information of the semiconductor product in the storage data index; and a procedure of controlling, by the storing method updating unit, movement of the evaluation data to the specific storage device among the plurality of storage devices in accordance with the storage data index, in the unit of manufacturing information of the semiconductor product. The storage medium is a non-transitory computer-readable storage medium. The storage medium includes a nonvolatile storage medium on which the program for causing the computer to execute the above-described procedures is recorded. The storage medium may be an external storage device such as a hard disk or a semiconductor storage device such as a memory. In practice, however, it is not limited to these examples.

### Advantageous Effects of Embodiment

As described above, in according to the embodiment, the semiconductor product evaluation data management system can be provided, the semiconductor product evaluation data management method, and the non-transitory computer-readable storage medium storing the semiconductor product evaluation data management program, capable of improving efficiency of the evaluation analysis of a large amount of evaluation data in evaluation data management of semiconductor products.

In particular, it is possible to shorten data obtaining time and analysis time by controlling data movement to the specific storage device (e.g., cold storage 22 (22_1, 22_2, 22_3)) in units of manufacturing information (e.g., unit of lot, unit of product, unit of shipping destination, unit of wafer, unit of process, etc.).

Moreover, the semiconductor product evaluation data management system, the semiconductor product evaluation data management method, and non-transitory computer-readable storage medium storing the semiconductor product evaluation data management program according to the embodiment, each include a data analysis program that models an expert's analytical procedure, and are configured to use the data analysis program to execute an automatic analysis of evaluation data, updating of a storage data index, movement ranking of the evaluation data to a storage, updating of a storing method of evaluation data in the storage, and the like. Consequently, it is possible to execute the data analysis and the data management similar to the experts.

### OTHER EMBODIMENTS

While certain embodiments have been described, these embodiments have been presented by way of examples only, and are not intended to limit the scope of the inventions. Indeed, the novel substrates, apparatuses, and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor product evaluation data management system comprising a computer server configured to manage evaluation data of a semiconductor product and a plurality of storage devices configured to store the evaluation data, the computer server comprising:
a storage data index file configured to store a storage data index attached to the evaluation data to be stored in the computer server and the plurality of storage devices;
a storage data index updating unit configured to store and update the manufacturing information of the semiconductor product in the storage data index; and
a storing method updating unit configured to control movement of the evaluation data to a specific storage device among the plurality of storage devices in a unit of the manufacturing information of the semiconductor product in accordance with the storage data index.

2. The semiconductor product evaluation data management system according to claim 1, wherein
the manufacturing information and evaluation analysis information of the semiconductor product are stored in the storage data index, wherein
the storing method updating unit controls the movement of the evaluation data to the specific storage device in the unit of the manufacturing information in accordance with the evaluation analysis information, a search frequency of the evaluation data, a data size of the evaluation data, and availability of the storage devices.

3. The semiconductor product evaluation data management system according to claim 1, wherein
the manufacturing information, evaluation analysis information of the semiconductor product, and correlation analysis information of evaluation data over a plurality of inspection processes are stored in the storage data index, wherein
the storing method updating unit controls the movement of the evaluation data to the specific storage device in the unit of the manufacturing information in accordance with the evaluation analysis information, a search frequency of the evaluation data, a data size of the evaluation data, the correlation analysis information of the evaluation data over the plurality of inspection processes, and availability of the storage devices.

4. The semiconductor product evaluation data management system according to claim 3, further comprising
a data movement ranking unit configured to execute machine learning using input of the evaluation analysis information, the search frequency of the evaluation data, the data size of the evaluation data, the correlation analysis information of the evaluation data over the plurality of inspection processes, and the availability of the storage devices, to calculate priority for moving the evaluation data to the specific storage device.

5. The semiconductor product evaluation data management system according to claim 1, wherein
the plurality of storage devices includes a hot storage and a cold storage, wherein
the storing method updating unit moves the evaluation data stored in the hot storage to the cold storage in accordance with the storage data index.

6. The semiconductor product evaluation data management system according to claim 5, wherein
the storage data index further comprises a storing flag for storing the evaluation data in the hot storage in the unit of the manufacturing information, wherein
the storage data index updating unit updates the storing flag with reference to a predetermined data storing rule, and
the storing method updating unit excludes the evaluation data to which the storing flag is attached from data to be moved to the cold storage.

7. The semiconductor product evaluation data management system according to claim 1, wherein
the units of manufacturing information is at least one unit selected from the group consisting of a unit of lot, a unit of product, a unit of shipping destination, a unit of wafer, and a unit of process.

8. The semiconductor product evaluation data management system according to claim 4, wherein
the priority is calculated on the basis of at least one of the evaluation analysis information, the search frequency of the evaluation data, and the data sizes of the evaluation data.

9. The semiconductor product evaluation data management system according to claim 5, wherein
the hot storage is a storage having a faster response speed than that of the cold storage, and the cold storage is a storage having a larger capacity than that of the hot storage.

10. A semiconductor product evaluation data management method executed by a semiconductor product evaluation data management system, the semiconductor product evaluation data management system comprising a computer server configured to manage evaluation data of a semiconductor product and a plurality of storage devices configured to store the evaluation data,
the computer server comprising a storage data index file configured to store a storage data index attached to the evaluation data to be stored in the computer server and the plurality of storage devices,
the semiconductor product evaluation data management method comprising:
in the computer server,
storing and updating, by a storage data index updating unit, the manufacturing information of the semiconductor product in the storage data index; and
controlling, by the storing method updating unit, movement of the evaluation data to a specific storage device among the plurality of storage devices in accordance with the storage data index, in a unit of manufacturing information of the semiconductor product.

11. The semiconductor product evaluation data management method according to claim 10, wherein
the manufacturing information and evaluation analysis information of the semiconductor product are stored in the storage data index, wherein
by the storing method updating unit, the movement of the evaluation data to the specific storage device is controlled in the unit of the manufacturing information in accordance with the evaluation analysis information, a search frequency of the evaluation data, a data size of the evaluation data, and availability of the storage devices.

12. The semiconductor product evaluation data management method according to claim 10, wherein
the manufacturing information, evaluation analysis information of the semiconductor product, and correlation analysis information of evaluation data over a plurality of inspection processes are stored in the storage data index, wherein
by the storing method updating unit, the movement of the evaluation data to the specific storage device is controlled in the unit of the manufacturing information in accordance with the evaluation analysis information, a search frequency of the evaluation data, a data size of the evaluation data, the correlation analysis information of the evaluation data over the plurality of inspection processes, and availability of the storage devices.

13. The semiconductor product evaluation data management method according to claim 12, wherein
in the computer server,
by a data movement ranking unit, machine learning is executed using input of the evaluation analysis information, the search frequency of the evaluation data, the data size of the evaluation data, the correlation analysis information of the evaluation data over the plurality of inspection processes, and the availability of the storage devices, and priority is calculated for moving the evaluation data to the specific storage device.

14. A non-transitory computer-readable medium in which a computer program is stored, the computer program being executed by a computer used for a semiconductor product evaluation data management system, the semiconductor product evaluation data management system comprising a computer server configured to manage evaluation data of a semiconductor product and a plurality of storage devices configured to store the evaluation data,
the computer server comprising a storage data index file configured to store a storage data index attached to the evaluation data to be stored in the computer server and the plurality of storage devices,
the computer program comprising:
in the computer server,
storing and updating, by a storage data index updating unit, the manufacturing information of the semiconductor product in the storage data index; and
controlling, by the storing method updating unit, movement of the evaluation data to a specific storage device among the plurality of storage devices in accordance with the storage data index, in a unit of manufacturing information of the semiconductor product.
